(19) United States
(12) Patent Application Publication
(10) Pub. No.: US 2004/0169674 A1
(43) Pub. Date: Sep. 2, 2004

(54) Method for providing an interaction in an electronic device and an electronic device

(75) Inventor: Jukka Linjama, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/750,525

(22) Filed: Dec. 30, 2003

(30) Foreign Application Priority Data
Dec. 30, 2002 (FI) 20022282

(51) Int. Cl. G09G 5/00

(52) U.S. Cl. 345/702

(57) ABSTRACT

A method and a device for providing an interaction between a user of an electronic device, and the electronic device, said device comprising an user interface and a motion sensor capable of detecting three dimensional motion. In the method; the user provides a gesture by touching the device, said gesture comprising at least one component of the three dimensions. The device detects said gesture and provides a tactile feedback in response to said gesture detection.

The present invention relates to a method and a device for providing an interaction and particularly, for providing a tactile interaction in an electronic device.

### BACKGROUND OF THE INVENTION

Traditionally the user controls the device by pressing keys or other controls located on a limited area on the surface of the device. The system response is presented in graphical display. This type of user interface is not very usable e.g. in the following cases. If the device is very small with small keys in the keyboard and the user has thick gloves in his/hers hand, there is no access to keys. If the device is very small with a small display and there is limited sight or the user does not wear glasses, it is difficult for the user to have access to the display.

In U.S. Pat. No. 6,466,198 provides a system and a method for view navigation and magnification of the display of hand-held devices in response to the orientation changes along only two axes of rotation as measured by sensors inside the devices. The view navigation system is engaged and controlled by a single hand, which simultaneously presses two ergonomically designed switches on both sides of the hand-held device. In other embodiments, the system engaged into the view navigation mode in response to an operator command in the form of a finger tap, or a voice command, or predefined user gestures. The response curve of the view navigation to sensed changes in orientation is dynamically changing to allow coarse and fine navigation of the view. Various methods are described to terminate the view navigation mode and fix the display at the desired view. Miniature sensors like accelerometers, tilt sensors, or magneto-resistive direction sensors sense the orientation changes. The system can be added to an existing hand-held device via an application interface of the device.

There is no direct access to the keys or the display if the device is wearable or in a pocket or a bag. There are also many situations where the users attention is in other task than controlling the device: communication through the device, or the environment may temporarily require attention.

### SUMMARY OF THE INVENTION

The present invention describes a solution for interaction with handheld or wearable device by providing at least some limited control of the device other than e.g. pressing a specific key in the keyboard. The method of the present invention is a combination of using a motion sensor tuned for sensing the control action (e.g. a tap) of the user and tactile feedback pulse signal, which is perceivable in a wide range of conditions.

Specific gesture, a tap or multiple taps, is used for controlling the device. Motion sensor (3 dimensional accelerometer, for example) is tuned to detect the tap on the surface of the device. Tap in any direction and position on the surface of the device is detected. Feedback from the device is provided by tactile means. Vibrating alert actuator is used to give a pulse that vibrates the device. This vibration can be felt also in most difficult cases. After the tap the user can hold his/hers hand in the location of the device, or press the device closer to his/hers body, in order to provide his/hers attention as a response. Visual and audible perception can also be directed to the environment or in the communication task. The present invention enables for the user successful use of the device in e.g. temporarily difficult situations, especially with limited access to controls and display or when traditional methods (visual or audible methods) are not possible to use. The intention of the present invention is to enhance the interaction to new, more sophisticated level.

According to a first aspect of the invention a method is provided for providing an interaction between a user of an electronic device, and the electronic device, said device comprising an user interface and a motion sensor capable of detecting three dimensional motion, characterized in that the method comprising the user providing a gesture by touching the device, said gesture comprising at least one component of the three dimensions, the device detecting said gesture and providing a feedback in response to said gesture detection.

According to a second aspect of the invention an electronic device is provided for providing interaction between to a user of said electronic device, said device comprising an user interface and a motion sensor capable of detecting three dimensional motion, characterized in that the device comprises detecting means for detecting at least one touch of the user touching the device, said gesture comprising at least one component of the three dimensions, feedback means for providing a feedback in response to said detected gesture.

According to a third aspect of the invention a computer program product is provided for an electronic device for providing interaction between to a user of said electronic device, said device comprising an user interface and a motion sensor capable of detecting three dimensional motion, characterized in that the computer program product comprises; computer program code for causing the device to detect at least one gesture of the user touching the device, said gesture comprising at least one component of the three dimensions, computer program code for causing the device to provide a feedback in response to said detected gesture.

In the following, the invention will be described in greater detail with reference to the accompanying drawings, in which

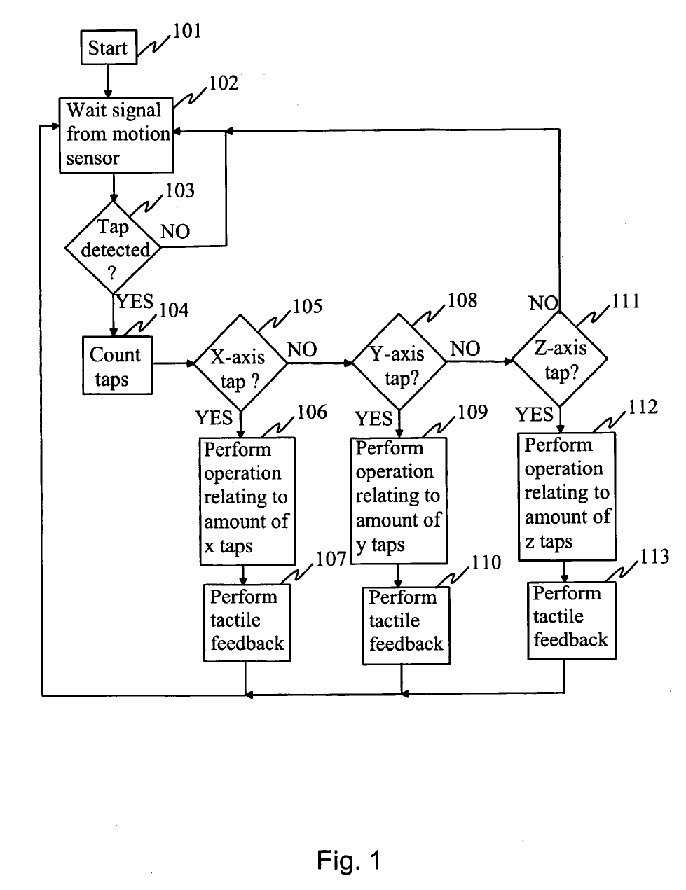

FIG. 1 illustrates a flow diagram of a method according to an embodiment of the invention,

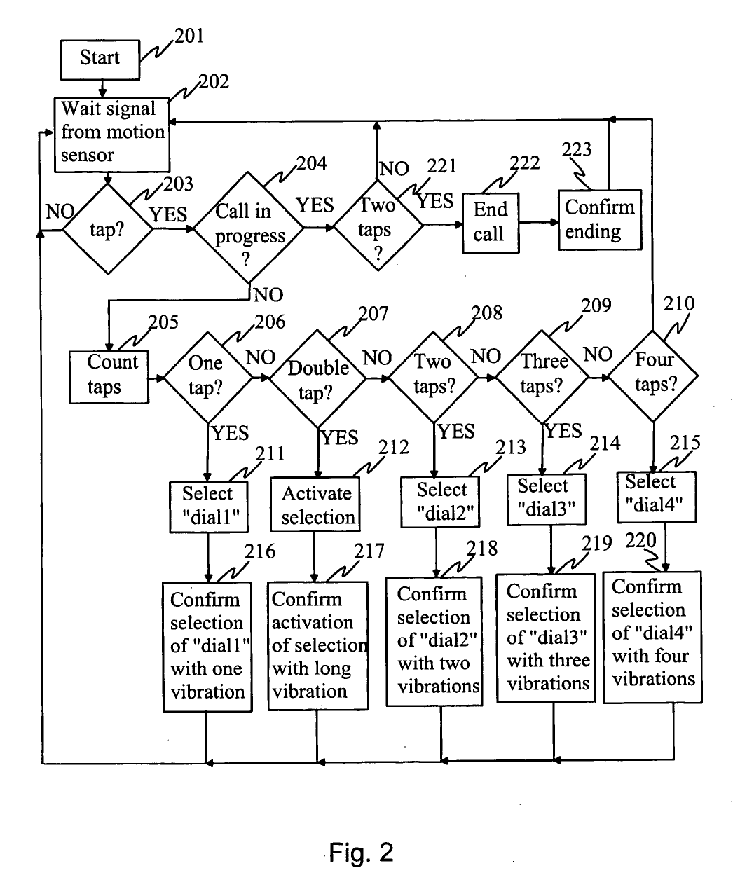

FIG. 2 illustrates a flow diagram of a method according to another embodiment of the invention,

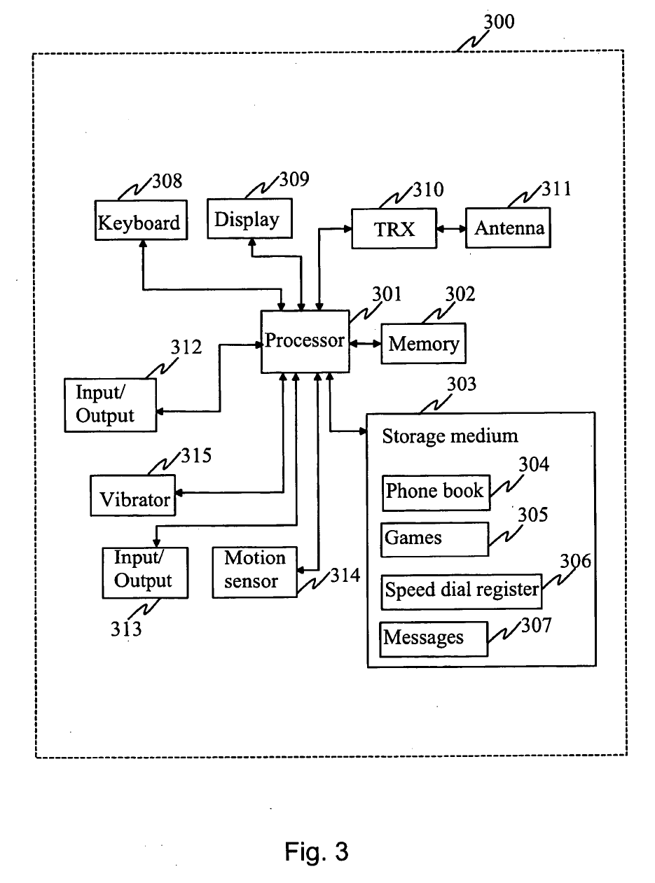

FIG. 3 illustrates a block diagram of an electronic device according to an embodiment of the invention and

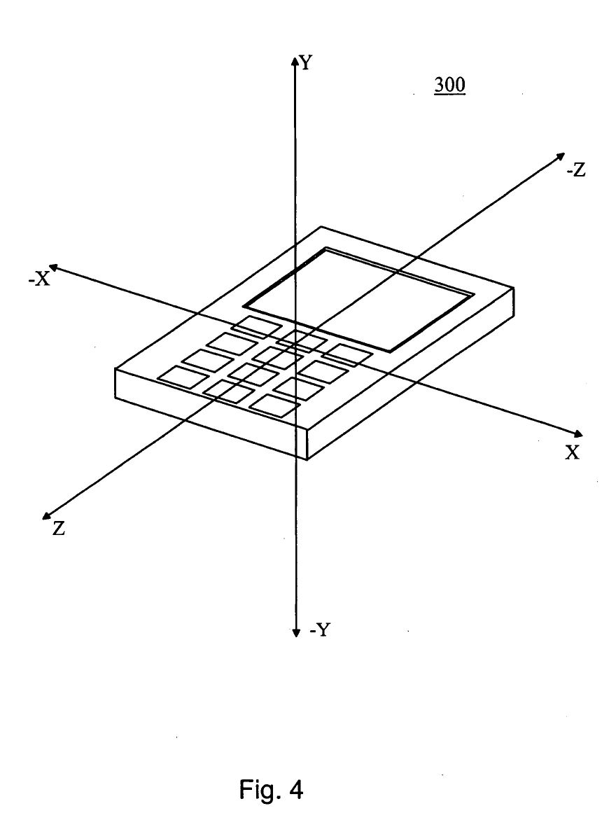

FIG. 4 illustrates a communication device according to an embodiment of the invention.

### DETAILED DESCRIPTION OF THE INVENTION

FIG. 1 illustrates a flow diagram of a method according to the first embodiment of the invention. The steps of the method can be implemented for example in a computer program code stored in a memory of an electronic device. When explaining this method a reference has been made to the device 300 being illustrated in FIGS. 3 and 4.

At step 101 the process begins, e.g. the device is started up and a menu structure is provided visually in a display of the device. At step 102 a signal from motion sensor 314 is received. At step 103 it is detected whether there is a detectable tap or not.

For example the duration and/or the intensity of the signal tells if there is tap in question or was the device dropped on the floor. If there was no tap at step 103 the flow proceeds to step 102. If there was a tap at step 103, the amount of taps is counted at step 104. If the tap or taps were tapped on the X-axis at step 105 as shown in FIG. 4, the flow proceeds to step 106, wherein an operation relating to the x tap or taps is performed. Next a tactile feedback is provided at step 107 to the user of the device by aid of a vibrator 315 as illustrated in FIG. 3. Similarly, if the tap or taps were tapped on the Y-axis at step 108 (or Z-axis at step 111) as shown in FIG. 4, the flow proceeds to step 109 (or step 112), wherein a operation relating to the y tap or taps is performed. Next a tactile feedback is provided at step 110 (or at step 113) to the user of the device by aid of a vibrator 315 as illustrated in FIG. 3.

FIG. 2 illustrates a flow diagram of a method according to the second embodiment of the invention. The steps of the method can be implemented for example in a computer program code stored in a memory of an electronic device. When explaining this method a reference has been made to the device 300 being illustrated in FIGS. 3 and 4. In this exemplary illustration, there is a speed dial register comprising four telephone numbers with names stored in the memory of the device 300. “dial 1” for name “Ronja” and for number “0400 123456”, “dial 2” for name “Olli”and for number “040 7123453”, “dial 3” for name “Aapo” and for number “041 567890”, and finally “dial 4” for name “Henri” and for number “0500 8903768”.

At step 201 the process begins, e.g. the device is started up and a menu structure is provided visually in a display of the device. Let us now assume that the user of the device is going to make a phone call to Henri (“dial 4”). First he/she selects the number being used, as illustrated in the following. The user of the device 300 taps four times. At step 202 a signal from a motion sensor 309 is detected. At step 203 it is detected whether there is a detectable tap or not. For example the duration and/or the intensity of the signal tells if there is a tap in question or was the device dropped on the floor. If there was no tap at step 203, the flow proceeds to step 202. If a tap is detected at step 203, it is next determined at step 204, whether a call is in progress or not. If there is no call in progress at the moment, the flow proceeds to step 205, wherein the taps are counted by e.g. a counter.

At steps 206-210 it is checked whether there was/were only one tap (step 206), a double tap (step 207), two taps (step 108), three taps (step 209) or four taps (step 210). In this example the user tapped four times, therefore the flow next proceeds to step 215 in order to select “dial 4” from the fast dial register. Next at step 220 the device forms a tactile feedback to the user by aid of a vibrator 315, in order to confirm the user that “dial 4 is now selected. The feedback can be for example four vibration pulses (duration e.g. 20 ms).

After that there are two alternatives to progress. In the first alternative after the feedback is produced at step 220, the device can make automatically a communication connection to “Henri” and to number “0500 8903768” and the flow proceeds from step 220 to step 202.

In the second alternative the flow proceeds to step 202 as described above, wherein a signal from the motion sensor 314 is again waited. The next thing the user now has to do is to activate the phone call by giving e.g. a double tap. The device detects the double tap (steps 203-207) and activates the selected number (step 212). Next the flow proceeds to step 217, wherein the device produces a tactile feedback in order to inform the user about confirmation of the activation. The feedback can be e.g. a single shake, or a longer lasting vibration pulse, e.g. five times as much as the vibration of one single vibration pulse.

When the user wants to end the phone call, he/she just taps twice (in this example) the device in order to terminate the phone call. The device detects at step 203 first tap, at step 204 it is also detected that the phone call is in progress and the flow precedes to step 221, wherein the taps are counted. If two taps are detected at step 221, the flow proceeds to step 222, wherein the call is terminated and finally the ending of the call is confirmed to the user with a vibration (step 223). After step 223 the flow proceeds to step 202.

Regarding to steps 206-210, the device detects the difference of taps e.g. as explained in the following. When the first tap is detected a counter in the device is reset (T=0) and it starts to count time (T=T+1). Let us assume here that one unit of time here is one millisecond (ms). If the next tap is detected in less than e.g. 200 ms, then a double tap is detected. If the next tap is detected in more than said 200 ms but in less than e.g. 4000 ms, then two taps is detected.

It is to be noted that the method according to the invention is not restricted to the examples as illustrated above. It is evident that other implementations are possible as well. E.g. the following examples can become in question; a phone is in a bag or pocket and a user wants to silent a disturbing incoming call alert and/or soft rejects the call (one or several taps). The user wants to enable speech recognition control. A tap activates the control and a vibration pulse or pulses (e.g. 5 pulses) confirm activation. A double tap can activate an emergency call. A single tap can activate a volume control for headset, a vibration to confirm said activation and further taps to increase or decrease the volume level. Fast forward (one tap) or fast rewind (two taps) for e.g. 5 seconds in voice messages. Furthermore, tap control can be combined with other gestures or control means, e g. tap enables shake/tilt gesture input for next 2 seconds time.

FIG. 3 illustrates a block diagram of an electronic device 300 according to an embodiment of the invention. The device comprises a processor 301 and a memory 302 for processing the operations being performed in the device 300. The device can also comprise a storage medium 303 for storing applications and information, e.g. Phonebook 304, Games 305, a speed dial register 306 and messages 307, like SMS and/or MMS messages. The device further comprises a keyboard 308 and a display 309 for inputting and outputting information from and to the user of the device. The device 300 is connectable to a communication network and/or to another devices by means of a transceiver 310, an antenna 311 and an Input/Output means 313 e.g. an infrared connection or cable connection, such as an USB-, Blue tooth, Serial- or Fire Wire connection, for example. The device 300 further comprises a motion sensor 314 for detecting motion, e.g. a tap and/or a gesture made by the user of the device. The motion sensor 314 is capable of detecting motion in at least one direction of at least one of the X, Y, or Z-axis as illustrated in FIG. 4. The motion sensor 315 can be capable of detecting motion to all six directions as illustrated in FIG. 4 (X, −X, Y, −Y, Z and −Z directions)

The device 300 is a wireless communication device, such as a mobile telephone operating in a communication system such as GSM system for example. The device can be further or alternatively a portable game console capable of providing to the user games stored in the device 300. For example the user can move a game cursor on the display of the mobile phone by tapping one of the sides of the mobile telephone. The user can accept his move for example by tapping the front of the mobile phone. By aid of transceiver 310 and antenna 311 or Input/Output means 313 it is possible to connect the device 300 in communication connection with one or several other game console devices in order to play network games.

FIG. 4 illustrates a communication device according to an embodiment of the invention. The figure illustrated the device 300 and a three dimensional coordinate system with X-, Y- and Z-axis.

The above disclosure illustrates the implementation of the invention and its embodiments by means of examples. A person skilled in the art will find it apparent that the invention is not restricted to the details of the above-described embodiments and that there are also other ways of implementing the invention without deviating from the characteristics of the invention. The above embodiments should thus be considered as illustrative and not restrictive. Hence the possibilities of implementing and using the invention are only restricted by the accompanying claims and therefore the different alternative implementations of the invention, including equivalent implementations, defined in the claims also belong to the scope of the invention.

1. A method for providing an interaction between a user of an electronic device (300), and the electronic device, said device comprising an user interface and a motion sensor (314) capable of detecting three dimensional motion, characterized in that the method comprises
the user providing a gesture by touching the device, said gesture comprising at least one component of the three dimensions,
the motion sensor (314) of the device (300) detecting said gesture and
the device (300) providing a feedback in response to said gesture detection.

2. A method according to claim 1, characterized in that said gesture selects a function of the device.

3. A method according to claim 1, characterized in that said gesture activates a function of the device.

4. A method according to claim 2 or 3, characterized in that said function is a scroll of a list in the user interface of the device.

5. A method according to claim 1, characterized in that said gesture moves a game cursor on the display of the device in two dimensions.

6. A method according to claim 5, characterized in that a further gesture in a third dimension of the device accepts the move made by the user in two other dimensions.

7. A method according to claim 2, characterized in that said selection is confirmed by said feedback.

8. A method according to claim 3, characterized in that said activation is confirmed by said feedback.

9. A method according to claims 7 and 8, characterized in that said feedback is at least one of the following: a tactile feedback, an audible feedback or a visual feedback.

10. An electronic device (300) for providing interaction between a user of said electronic device, said device comprising an user interface and a motion sensor (314) capable of detecting three dimensional motion, characterized in that the device comprises
detecting means (301, 302, 314) for detecting a gesture comprising at least one component of the three dimensions which gesture is provided by at least one touch of the user
feedback means (301, 302, 315) for providing a feedback in response to said detected gesture.

11. A device according to claim 10, characterized in that said detecting means are arranged to select a function in response to said detected gesture.

12. A device according to claim 10, characterized in that said detecting means are arranged to activate a function in response to said detected gesture.

13. A device according to claim 11, characterized in that said feedback means are arranged to inform the user about the confirmation of said selection.

14. A device according to claim 12, characterized in that said feedback means are arranged to inform the user about the confirmation of said activation.

15. A device according to claims 13 and 14, characterized in that said feedback means are arranged to provide at least one of the following feedback: a tactile feedback, an audible feedback or a visual feedback.

16. An electronic device according to claim 10, characterized in that said gesture is arranged to move a game cursor on the display of the device in two dimensions.

17. A method according to claim 16, characterized in that a further gesture in a third dimension of the device is arranged to accept the movement made by the user in two other dimensions.

18. A device according to any of claims 10 to 17, characterized in that said device is at least one of the following: a portable game console or a wireless communication device.

19. A computer program product for an electronic device (300) for providing interaction between a user of said electronic device, said device comprising an user interface and a motion sensor (314) capable of detecting three dimensional motion, characterized in that the computer program product comprises
computer program code for causing the device to detect at least one gesture of the user touching the device, said gesture comprising at least one component of the three dimensions,
computer program code for causing the device to provide a feedback in response to said detected gesture.
